(19) United States
(12) Patent Application Publication
(10) Pub. No.: US 2024/0011946 A1
(43) Pub. Date: Jan. 11, 2024

(54) Ultrasonic Sensor Arrangement

(71) Applicant: Tribosonics Limited, Sheffield (GB)

(72) Inventors: Philip Brian Harper, Sheffield (GB); Ricky Dane Shepherd, Sheffield (GB); Jack Sands, Sheffield (GB)

(21) Appl. No.: 18/253,291

(22) PCT Filed: Nov. 19, 2021
(86) PCT No.: PCT/EP2021/082354

§ 371 Date: May 17, 2023

(30) Foreign Application Priority Data
Nov. 19, 2020 (GB) 2018204.4

(51) Int. Cl. G01N 29/04; G01M 13/045; F16C 41/00; G01N 29/24

(52) U.S. Cl. CPC G01N 29/043; G01M 13/045; F16C 41/00; G01N 29/2481; G01N 2291/2696; G01N 2291/0289; F16C 2233/00

(57) ABSTRACT

Disclosed is a bearing comprising: an inner race and an outer race having a plurality of rolling elements therebetween and defining an axis of rotation about which the inner and outer race rotate relative to one another; an ultrasonic transducer mounted to either the inner race or the outer race and a transducer transceiver electrically connected to the transducer and configured to wirelessly transmit electrical signals for the transducer.

### FIELD OF INVENTION

The invention relates to a wireless ultrasonic sensor arrangement for obtaining data from a rotating component, such as a bearing. The arrangement may utilise a wireless coupling to transmit a signal to and from an ultrasonic transducer mounted on a rotating component. In particular, though not exclusively, the invention relates to a bearing, such as a rolling element bearing.

### BACKGROUND

Rolling element bearings, such as the one shown in FIG. 1, are prone to wear and failure of various kinds, as is well known in the art. To reduce the impact of wear related failures it is known to monitor in-service operating characteristics of bearings such that a potentially faulty or worn bearing may be detected and replaced at a convenient time such as a scheduled maintenance window.

One method in which bearings are known to have been monitored and analysed is using ultrasonic measurements. Ultrasonic acoustic waves provide a convenient way of interrogating and extracting data from bearings by injecting an ultrasonic pulse or wave into the component and detecting the reflected sound wave which is modified by the interaction with the bearing. Analysing the signal resulting from the reflected wave can provide information on various characteristics of the bearing and provide an indication as to the condition of the bearing.

U.S. Pat. No. 6,571,632 describes a rolling element bearing in which the time of flight of an acoustic wave is used to determine the real-time dynamic stress, temperature and rotational speed of the bearing. The arrangement relies on through-transmission of an acoustic wave through a race and includes a transmitter on one axial face of the inner or outer race with a receiver on the opposing face. An acoustic signal in the form of a pulse is transmitted through the race and the time of flight analysed to determine the stress (the time of flight being variable with stress). Temperature is estimated by measuring a base level offset in the received acoustic signal (i.e. a DC voltage offset) with the rolling element stress being analysed using changes in the AC component of the received signal. Speed of the bearing is estimated using the passing frequency of the rolling element with respect to the transducer.

The present invention seeks to provide an improved apparatus and method for obtaining characteristic operating data from a rolling element bearing.

### SUMMARY

The present invention provides a bearing, a wireless ultrasonic transducer arrangement and a method of determining or measuring a bearing parameter or characteristic according to the appended claims.

The present disclosure provides a bearing comprising: an inner race and an outer race having a plurality of rolling elements therebetween and defining an axis of rotation about which the inner and outer race rotate relative to one another; an ultrasonic transducer mounted to either the inner race or the outer race and a transducer transceiver electrically connected to the transducer and configured to wirelessly transmit electrical signals for the transducer.

By wirelessly transmitting electrical signals to the ultrasonic transducer, using the transducer transceiver, the reliability of a connection between the ultrasonic transducer and external components (e.g., an electrical signal unit, as described further below) is improved. A wireless link can be less bulky, less fragile and less susceptible to the ingress of contaminants than an electrically-conducting connection such as a slip ring.

Additionally, in some examples of the present disclosure, the wireless ultrasonic transducer arrangement uses the wireless link to measure properties of the bearing that are not measurable by the ultrasonic transducer alone. For example, the wireless link can be used to measure the rotational speed of the inner or outer race and/or bearing slip. As another example, the wireless link can be used to detect and/or measure axial movement of the bearing. Thus, the wireless link can allow additional properties of the bearing to be measured, as well as providing a more reliable connection between the ultrasonic transducer and external components.

The transducer transceiver may comprise a plurality of discrete sub-transceivers distributed around the rotational axis on the race. The transducer transceiver may comprise an electrical coil.

The transducer transceiver may comprise an elongate electrical coil which extends around the rotational axis of the bearing. The coil may extend around at least 90 degrees, or optionally at least 180 degrees, or optionally at least 270 degrees.

The bearing may comprise a plurality of transducers. There may be one or more transducers on the inner race, and/or, one or more transducers on the outer race. The transducer may be an inner race transducer and the bearing may further comprise an outer race transducer.

The number of transducers of either or both the inner race or outer race may be between four and one hundred and twenty eight transducers.

The ultrasonic transducer may be surface mounted (which may otherwise be referred to as direct mounting) on the inner or outer race. Surface mounting of an ultrasonic transducer is advantageous when the bearing is subject to high loads. This is because surface mounting avoids the need to modify the shape of the bearing to incorporate the transducer, and thus avoids reducing the structural strength of the bearing. Moreover, the use of an ultrasonic transducer is superior to some types of non-ultrasonic transducer (e.g., surface acoustic wave transducers), which may require part of the bearing to be cut away—often in the region in which the bearing experiences maximum load or maximum stress—in order to accommodate the transducer and thereby maximise its sensitivity. In contrast, an ultrasonic transducer does not need to be placed within the bearing to achieve adequate sensitivity.

Alternatively, the ultrasonic transducer may be embedded within the inner or outer race. This may be advantageous in applications where it is impractical for the transducer to project outside the envelope of the bearing. The ultrasonic transducer can be embedded away from a region of the inner or outer race that experiences maximum load or maximum stress. In other words, the ultrasonic transducer can be embedded in a region of the inner or outer race that experiences a relatively low load or a relatively low stress when the bearing is in use. Unlike the non-ultrasonic transducers discussed above, the ultrasonic transducer can achieve adequate sensitivity even when it is not embedded within a region that experiences maximum load or maximum stress. Thus, the ultrasonic transducer can be embedded in a region of the bearing where it does not interfere with the operation and/or performance of the bearing.

The transducer may be surface mounted or embedded within an axial face of the inner or outer race. The axial faces of the races are typically more accessible than the radial faces and, therefore, mounting the transducer on or within an axial face can allow the transducer transceiver to be positioned where it can be closely electromagnetically coupled to a stationary transceiver. In an example in which transducer transceiver (and, optionally, the transducer itself) are positioned (e.g., surface mounted or embedded) on an axial face, axial movement of the bearing can be monitored by detecting and/or measuring changes in the electromagnetic coupling between the transducer transceiver and the stationary transceiver. For example, when axial movement of the bearing causes an increase in the distance between the transducer transceiver and the stationary transceiver, this may decrease the amplitude of signals received by one transducer from the other transducer (and vice versa). In this manner, the wireless link can be used to detect and/or measure an axial movement of the bearing that cannot be measured by the ultrasonic transducer alone. Thus, a more complete understanding of the properties of the bearing can be achieved by using the wireless link to measure axial properties of the bearing (including, but not limited to, axial movement) and using the ultrasonic transducer to measure radial properties of the bearing.

Alternatively, the transducer may be surface mounted or embedded within a radial face of the inner or outer race.

The transducer transceiver is directly mounted on the inner or outer race. Alternatively, the transducer transceiver may be mounted on an adjacent or adjoining structure to the bearing such as a bearing housing or other structural support for the bearing.

The present disclosure provides a wireless ultrasonic transducer arrangement for a rolling element bearing comprising: the bearing according to any bearing of the present disclosure, a wireless coupling comprising: the transducer transceiver electrically connected to the transducer and a stationary transceiver electrically connectable to an electrical signal unit, wherein the transducer transceiver and the stationary transceiver are arranged in a spaced relation and configured to transmit electrical signals between the transducer and an electrical signal unit.

The wireless ultrasonic transducer may further comprise a plurality of transducer transceivers and/or a plurality of stationary transceivers.

The or each transducer transceiver and/or the or each stationary transceiver may be configured to transmit the electrical signal around an arc of at least 90 degrees of the rotational axis.

The stationary transceiver may comprise at least one electrical coil and, optionally, wherein the at least one stationary transceiver coil extends around an arc of at least 90 degrees or at least 180 degrees or at least 270 degrees with respect to the rotational axis.

The plurality of stationary transceivers may be distributed around the rotational axis.

The wireless ultrasonic transducer arrangement may further comprise an inner race stationary transceiver and an outer race stationary transceiver.

The wireless ultrasonic transducer arrangement may further comprise a transceiver device comprising the stationary transceiver, wherein the transceiver device is arranged in a fixed relation to the rotational axis.

The transceiver device may comprise one or more locating features for locating the transceiver device adjacent to the transducer transceiver on either of both of the inner or outer race in a predetermined position.

The wireless ultrasonic transducer arrangement may further comprise the electrical signal unit.

The electrical signal unit may comprise a signal processing unit configured to determine any one or more of the group consisting of: a rotational speed of the inner or outer race;

a bearing slip; a raceway temperature; a mechanical flaw in the bearing; one or more characteristics of a lubricant located between the inner or outer race; and, vibration.

The electrical signal unit may comprises an output device configured to output a characteristic of the bearing to a user.

The present disclosure provides a method of determining one or more characteristics of a rolling element bearing using a wireless ultrasonic transducer arrangement comprising: a bearing comprising an inner race and an outer race having a plurality of rolling elements therebetween and defining an axis of rotation about which the inner and outer race rotate relative to one another; an ultrasonic transducer mounted to either or both of the inner race or the outer race; a wireless coupling comprising: a transducer transceiver electrically connected to the transducer and a stationary transceiver electrically connected to an electrical signal unit, wherein the transducer transceiver and the stationary transceiver are arranged in a spaced relation and configured to transmit or receive the electrical signal between the transducer and the electrical signal unit, the method comprising the steps of: transmitting an excitation electrical signal over the wireless coupling; receiving the excitation electrical signal by the transducer and generating an acoustic wave in response to the excitation electrical signal; receiving a response acoustic wave at the transducer and generating a corresponding response electrical signal; and, transmitting the response electrical signal over the wireless coupling to the electrical signal unit.

The method may, further comprise: receiving the response electrical signal at the electrical signal unit; processing the response electrical signal to determine one or more characteristics of the response electrical signal; and determining a characteristic of the bearing using the one or characteristics of the response electrical signal.

The characteristic of the response electrical signal may comprise the amplitude or phase of the response electrical signal.

The characteristic of the bearing may comprise one or more taken from the group comprising: a rotational speed of the inner or outer race; a bearing slip; a raceway temperature; a mechanical flaw within the bearing; one or more characteristics of a lubricant located between the inner or outer race; and, a vibration in the bearing.

The excitation electrical signal may comprise a plurality of sequential pulse signals.

The electrical signal may be transmitted between the transducer and electrical signal unit for at least 90 degrees of each revolution of the inner or outer race.

The method may further comprise providing an output signal to a user, the output signal being representative of one or more bearing characteristic.

The method may further comprise: comparing the response electrical signal or one or more of the characteristics thereof with a known response electrical signal or corresponding characteristic; and, determining whether the bearing is operating within permitted tolerances on the basis of the comparison.

The method may further comprise: obtaining a first characteristic from either of the inner race and outer race; obtaining a second characteristic from the other of the inner race and outer race, wherein the first and second characteristics are different.

The method may further comprise determining a temperature or change in temperature of the bearing, wherein the temperature or change of temperature is determined from a change in or the gradient of the time of flight.

The method may further comprise: determining the speed of rotation of the bearing from a periodic drop off of the response electrical signal caused by a misalignment of the stationary transceiver and the transducer transceiver in the wireless coupling.

The method may further comprise: determining bearing slip from a comparison of the rotational speed of the bearing and the passing frequency of the rolling elements.

The skilled person will appreciate that, except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

### BRIEF OVERVIEW OF FIGURES

The invention will now be described, by way of example only, with reference to the accompanying drawings, in which:

FIG. 1 shows a conventional rolling element bearing;

FIG. 2 shows a wireless ultrasonic transducer arrangement;

FIG. 3 shows a rolling element bearing comprising an ultrasonic transducer embedded in the outer race;

FIG. 4 shows an alternative rolling element bearing;

FIGS. 5a and 5b show an extended contact coil;

FIGS. 6a and 6b show a distributed coil arrangement;

FIGS. 7a and 7b show a transceiver device;

FIG. 8 shows an electrical signal unit;

FIG. 9 shows a method of operating the transducer arrangement;

FIGS. 10a to 10d show various electrical signals generated by the transducer arrangement; and,

FIGS. 11a and 11 b show alternative electrical signals generated by the transducer arrangement.

### DETAILED DESCRIPTION

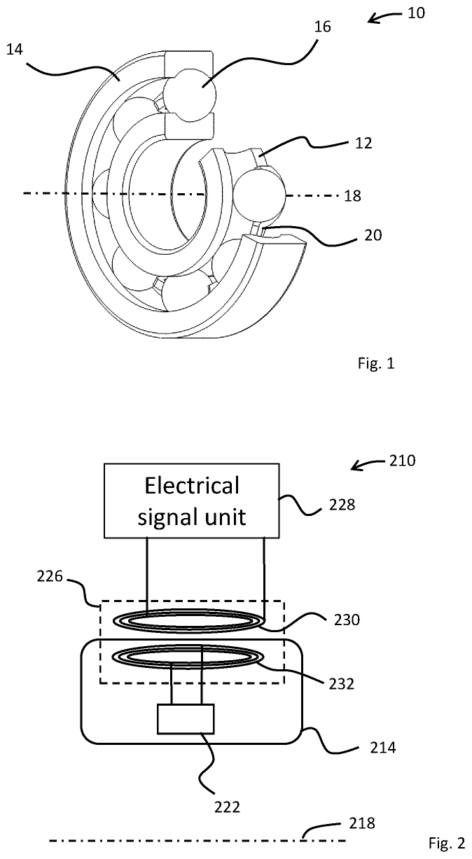

FIG. 1 shows a rolling element bearing 10. The bearing 10 is conventional comprising an inner race 12, an outer race 14 and a plurality of rolling elements 16 therebetween. Although not shown, the bearing 10 will typically be mounted on a shaft which is configured rotate on a rotational axis 18. It will be appreciated that in some examples the outer race 14 may be configured to rotate relative to a stationary inner race, or both the inner 12 and outer 14 races may be configured to each rotate, for example, in an inter-shaft bearing.

Each race 12, 14 includes a contact surface for contacting the respective opposing side of the rolling elements 16. Thus, the inner race 12 has a radially outwardly facing contact surface and the outer race 14 has a radially inwards facing contact surface. As shown in FIG. 1, the contact surfaces may be provided by grooves in which the rolling elements 16 are located and retained. The grooves may have a shape which corresponds to the opposing contact surface of the rolling elements 16. Hence, as shown, there is provided an annular groove which extends around the rotational axis 18 and which is arcuate in an axially extending cross-section.

The bearing 10 may be lubricated so as to have at least a film of lubricant between the rolling elements 16 and the contact surface of the respective race 12, 14. The bearing may also be sealed or shielded with a barrier located within gap between the inner and outer races 12, 14.

The rolling elements 16 shown in FIG. 1 are in the form of ball bearings which are evenly distributed around the rotational axis 18. A spacer/cage 20 may be used to control the relative spacing of the rolling elements 16. Although FIG. 1 shows rolling elements 16 in the form of ball bearings, it will be appreciated that the invention may be applied to bearings comprising cylindrical, needle, spherical, tapered or other rolling elements. It will also be appreciated that the invention may be applied to radial, thrust and/or linear bearings. Other examples of other suitable bearings may exist. Further, the invention may find application in bearings other than rolling element bearings or other structures which are configured to rotate relative to one another. Further still, in the broadest sense, the invention may find application in any rotating component where ultrasonic interrogation of the rotating component is required.

FIG. 2 shows a wireless ultrasonic transducer arrangement 210 for a rolling element bearing. As described above in connection with FIG. 1, the bearing may be any suitable bearing or other rotating component and may comprise an inner race (not shown) and an outer race 214 having a plurality of rolling element bearings (not shown) therebetween to define an axis of rotation 218 about which the inner and outer race 218 can rotate relative to one another. In use, the bearing may form part of an apparatus or machine and provide rotational support for a shaft or other rotating part with either or both of the inner and outer race 214.

The arrangement 210 comprises an ultrasonic transducer 222 mounted to either the inner race or, as shown, the outer race 214. The mounting of the transducer 222 is shown schematically in FIG. 2 as being embedded deep within the race 214 but it may be directly or indirectly attached to the race 214 and may be surface mounted or embedded within the body of the race 214. By indirectly mounted it will be appreciated that the transducer 222 may be mounted on a bearing housing or other support structure provided the acoustic wave issued from the transducer 222 can penetrate the bearing race 214 and/or rolling elements, as required. It will also be appreciated that, for the purposes of this disclosure, the transducer 222 may be mounted using a suitable acoustic coupling material such as an adhesive, mating compound or shim, for example, whilst still being considered to be directly mounted. Such mounting means are conventional and well known in the art.

The position at which the transducer 222 may be configured to be a pulse-echo transducer or a through-transmission transducer as desired for a particular application. As shown in FIG. 2, the transducer 222 may be provided in an axial mounted position in which acoustic waves are transmitted through the race in the direction of the rotational axis of the bearing, or a radial mounted position in which the acoustic waves are transmitted radially towards or away from the rotational axis 218. Thus, in the case of a radial bearing, the transducer 222 may be located towards a radially outer surface of the outer race 214, a radially inner surface of an inner race, or either axially facing surface of the inner race and outer race 214. In some examples, the transducer 222 may be located on the cage. In some examples, the rolling elements may comprise the transducer 222.

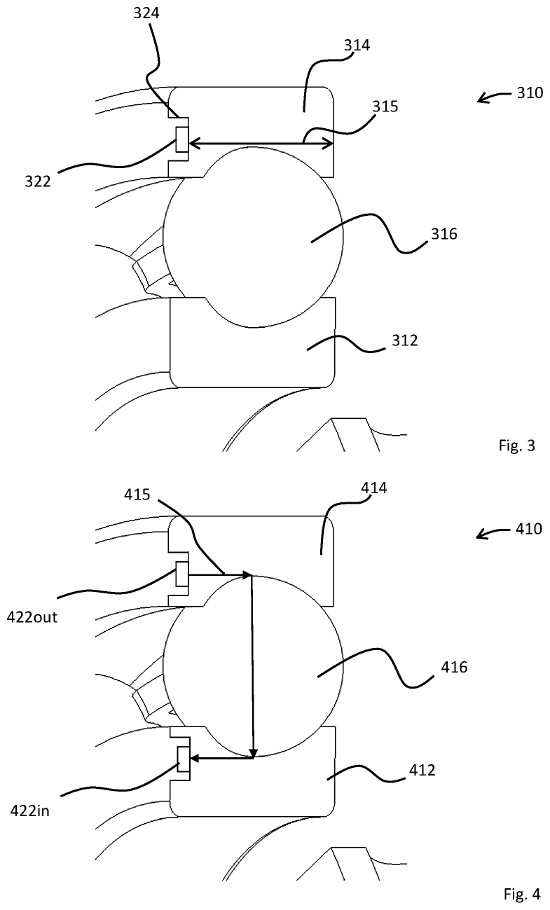

FIG. 3 shows an example bearing 310 comprising an inner race 312, an outer race 314 and a plurality of rolling elements 316 in which the transducer 322 is positioned axially in or on the outer race 314 and configured to transmit an acoustic wave into the bearing 310 in an axial direction. That is, generally in the direction of or parallel to the rotational axis (not shown). In the example shown here, the transducer 322 is mounted on an axial end face of the outer race within a recess 324.

The recess 324 may be provided purposely for receiving the transducer 322. The recess 324 may provide a convenient way of locating the transducer 322 in the required position. The recess 324 may have a depth which is sufficient to fully receive the transducer 322 such that it does not project outside of the recess 324 and is retained below the respective outside surface of the race 314. Providing an embedded transducer 322 provides a degree of protection against being knocked or disturbed during installation or use of the bearing 310. The recess 324 may also provide a convenient way of securing the transducer 322 in the required position using, for example, a potting compound which can be used to backfill the cavity 324 behind the transducer once mounted.

The radial position of the axially facing transducer 322 may be selected to provide an appropriate wave transmission path in relation to the rolling elements 316. In the example shown, the wave transmission path is adjacent to the radially outer contact surface of the rolling element 316 such that the acoustic wave is modified by stress fields in the contact region and/or properties of the lubricant film located between the rolling element 316 and outer race 314. More specifically, the transmission path may be tangential to the apex of the contact surface or groove in which the rolling element 316 is located, as indicated by arrow 315. However, this is not a limitation and other locations and orientations for the transducer 322 and wave transmission path are possible. It will also be appreciated that the transducer 322 may be mounted on the inner race 312, cage or rolling element, for example.

FIG. 4 shows an alternative bearing arrangement 410 which utilises through-transmission in which an acoustic wave transmission path extends through the outer race 414, rolling element 416 and inner race 412. Hence, there is provided a transmitting transducer 422out on the outer race 414 and a receiving transducer 422in on the inner race 412, however, these may be interchangeable and the acoustic wave may be transmitted from the inner race 412 to the outer race 414 in some examples. Further, each of the transducers 422out, 422in may be used independently of each other such that the inner 412 and outer 414 race and their respective lubricant film or rolling element interface/contact surface can be separately interrogated and analysed using a pulse-echo method (or continuous wave, chirp or other signal enveloping). Hence, the inner race 412 may be interrogated during a first time interval, the outer race 414 may be interrogated during a second time interval, and a through-bearing interrogation may be carried out during a third time interval. Other combinations of interrogation will be possible.

Providing a through-transmission path through the bearing elements independently from or in combination with pulse-echo type techniques of the inner 412 and/or outer 414 race may be advantageous for determining additional characteristics of the bearing arrangement. For example, such an arrangement may allow for monitoring of the rolling element and both lubricant films with a single measurement. Alternatively or additionally, it may allow for stress through the rolling element to be monitored, or subsurface defects in the ball to be detected. In some examples, the arrangement may allow simultaneous measurement of the lubricant films from each interface. Such measurements may be used to determine wear of the rolling elements.

Although not shown it will be appreciated that other arrangements of transducer are possible in relation to a bearing. For example, each race may incorporate a plurality of transducers provided on axially opposed surfaces so that a through-transmission of either or both races may be carried out. Hence, in the example of FIG. 3, there may be a second transducer provided opposite the first transducer 322 on the opposing axial face of the outer race 314.

Returning to FIG. 2, the transducer arrangement 210 may comprise a wireless coupling 226 which is shown generally by the dashed box. The wireless coupling 226 may be configured such that electrical signals can be transmitted between the transducer 222 and an external electrical signal unit 228. The wireless coupling 226 removes the need for a hardwired connection to the transducer 222 meaning that relative rotation between the transducer 222 and an electrical signal unit 228 may be achieved.

Further, providing relative rotation between the transducer 222 and a stationary transceiver 230, may provide a further parameter which can be utilised to determine a characteristic of the bearing being assessed. For example, the wireless coupling 226 may comprise a stationary transceiver 230 which is stationary with respect to a transducer transceiver 232 and the transducer 222 such that there is relative rotation between the two transceivers 230, 232. The passing frequency of the two transceivers 230, 232 may provide an indication of the rotational speed of the transducer 222. Hence, where the transducer 222 is provided on a rotating race, for example, the inner race of a shaft bearing, and the stationary transceiver is mounted to a fixed support structure, the rotational speed of the inner race and shaft may be determined by the period of the passing frequency.

Further, the relative rotational speed of the rotating race and the rolling elements may be obtained and the presence and/or amount of a rolling element slip determined.

As noted in connection with FIG. 4, in some examples, a transducer 222 may be mounted on both of the inner 412 and outer 414 races such that the relative rotation of the inner 412 and outer 414 race can be determined. This may be useful where both the inner 412 and outer 414 race are configured to rotate, for example, in an inter-shaft bearing.

The wireless coupling 226 may be achieved using a stationary transceiver 230 which is stationary with respect to the rotating component, e.g. the rotating race or shaft, and a transducer transceiver 232 or which is mounted to the race being interrogated and which has the transducer mounted to it. The transducer transceiver 232 may be stationary or rotating depending on the application.

The transceivers 230, 232 may be configured to transmit electrical signals to or receive electrical signals from the transducer 222. The electrical signals may include an excitation signal such as a pulse signal or continuous wave signal for exciting the ultrasonic transducer 222, or an output signal from the transducer 222 which is communicated to a signal processing unit via the wireless coupling 226.

The wireless coupling 226 may additionally transmit the electrical power required for the transducers 222 and/or any other additional sensors or circuitry which are provided on the race 214. Hence, additional sensors, such as a temperature or vibration, may also be mounted to or embedded within the race 214 or rotating component such that the temperature or some other parameter can be measured. It will be appreciated that other parameters, such as temperature, may affect the acoustic properties of the bearing and being able to directly measure these parameters may be advantageous.

The transceivers 230 and 232 may be provided by conductive coils as is well known in the art. The coil geometry, dimensions, location, and materials will be application specific and determined using known techniques and principles of wireless coupling and power transfer systems. Typically, the coils will be generally planar comprising a plurality of windings of conductive material provided in a spiral. Other examples of suitable transceivers, e.g. antennas may be known in the prior art. The antennas may take any suitable geometries for providing the necessary or optimal transmission of the signal and/or optimal signal integrity

A transducer transceiver 232 may be electrically connected to the transducer 222 and configured to transmit or receive electrical signals to or from the transducer 222. The transducer transceiver 232 may be mounted to or embedded within the race 214 in close proximity to the transducer 222. The transducer transceiver 232 may be received within the recess 324 (shown in FIG. 3) with the transducer 322. The transducer 222 and transducer transceiver 232 may be provided as a single unit which is mounted to a surface of the respective race 214 and/or received within a recess, as described above. The transducer transceiver 232 may be fixed to the race using any appropriate means such as with an adhesive or potting compound, for example.

In some examples, the transducer transceiver 232 may be located relatively remotely from the transducer 222 and possibly remotely from the race 214. Thus, the transducer transceiver 232 may be provided in a more convenient location for being wirelessly coupled to the stationary transceiver 230. The remote location may be a housing or other rotating structure which surrounds the bearing and rotates with the race.

In use, the stationary transceiver 230 is located in a spaced relation to the transducer transceiver 232 and is configured to transmit or receive the electrical signals to or from the transducer transceiver 232. The separation of the transceivers 230, 232 may be determined by the level of wireless coupling and power transfer required to communicate the electrical signal between the two transceivers 230, 232 and to allow sufficient separation for relative rotation. The required separation will be application specific and determined according to well-known principles.

The respective electrical connections between the transducer transceiver 232 and transducer 222, and the stationary transceiver 230 and electrical signal unit 228, may be any suitable connection which allows the electrical signals to be communicated therebetween. As shown in FIG. 2, the connections may be provided by conventional hardwiring. In other examples, the communication between the stationary transceiver 232 and electrical signal unit 228 may comprise a further wireless component.

As used herein, the term electrical signal unit 228 may be used to represent one or more electronic devices or circuits for generating and/or processing an electrical signal. The electrical signal may be an excitation signal for transmission to the transducer 222 such that an ultrasonic wave can be generated by the transducer 222, or a measurement signal received from the transducer 222 which corresponds to the received reflected or through-transmission acoustic wave. Thus, the electrical signal unit 228 may comprise a signal generator for generating the excitation signal and/or a signal processor for processing the received measurement signal. The electrical signal unit 228 may also be configured to provide one or more output signals or display signals indicative of a characteristic of the bearing. Examples of the various electrical signals and output signals/display signals are discussed further below.

In some examples, the electrical signal unit 228 may comprise a signal generator configured to provide the output signal for driving the transducer 222 and a memory for storing a response signal. The stored response signal may be uploaded/downloaded or otherwise transmitted to a signal processing unit for processing at a later time. Thus, in some examples, the data from a transducer 222 may be temporarily captured and stored in the electrical signal unit 228 for processing at a later time. This may be advantageous where a number of readings are to be captured on a portable electrical signal unit from different locations.

In some embodiments, the electrical signal unit 228 may transmit or receive an excitation signal and/or measurement signal to a central electrical signal unit which carries out the signal generator and/or signal processing. The connection between the electrical signal unit 228 and a central electrical signal unit may be via a known communication network and achieved using conventional transmission technology. Thus, the electrical signal unit may communicate with the central electrical signal unit via the internet, a wide area network, a wireless local area network, or short-range wireless communications using known standards and/or protocols, such as TCP/IP, WiFi® or Blutooth®, for example. The electrical signal unit may be connected to a plurality of separate electrical signal units.

The transducers 322, 422out, 422in, and transducer transceivers 232 shown in FIGS. 3 and 4 are shown as having a relatively small arcuate footprint area meaning that the data capture window is limited to only a small arcuate section of the bearing at any one time or per revolution of the race. However, it may be advantageous in some examples to capture data for an extended period of a single revolution of the one of the race 214 or to take repeated or different measurements at different angular locations around the rotational axis 218. For example, providing a longer data acquisition window or measurements at different points may allow detection of dynamic loading that has a frequency content higher than the rotational speed of the shaft. In such a case, multiple measurements may help to avoid aliasing of the signal. Also, if there is a variation between the rolling elements then it may be advantageous to have successive measurements on the bearing per revolution.

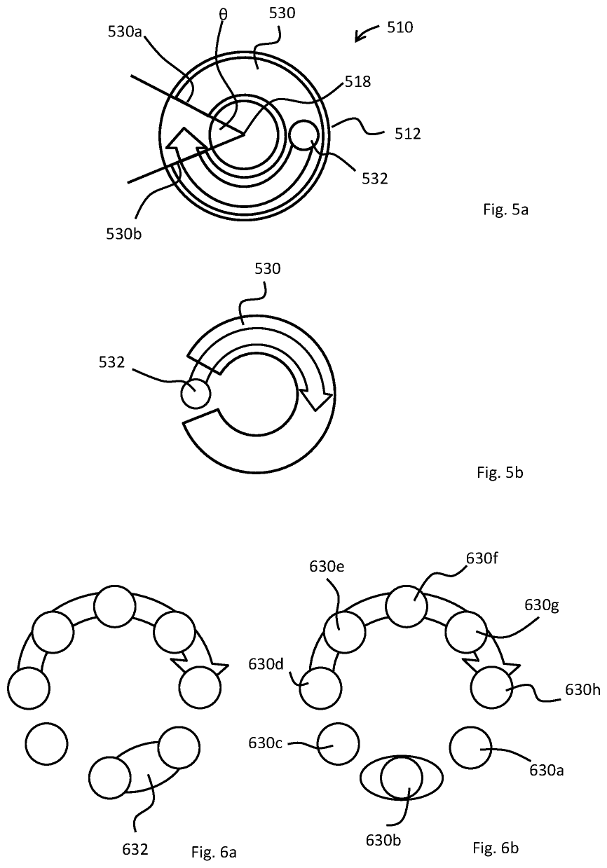

FIGS. 5a and 5b, and FIGS. 6a and 6b, show alternative examples of transceivers which may be utilised within a wireless coupling 226 and which are configured to transmit electrical signals at different locations around the circumference of one of the races. Hence, the transceiver may be distributed around the rotational axis (which is viewed end-on) so as to allow electrical signals to be transmitted for an extended period of a revolution or at different locations.

The transceiver may comprise a generally elongate coil which extends about the rotational axis (FIGS. 5a and 5b), or a distributed transceiver having a plurality of transceivers arranged around the rotational axis as shown in FIGS. 6a and 6b.

In the example of FIGS. 5a and 5b, the transceiver 510 is provided by an elongate coil which is provided against an axial face of the bearing (or radial as the case may be) and extends around a race 512 so as to encircle the rotational axis 518 through an arc thereby having an arcuate length. The extent of the arc will be application specific and determined in part by the duration of the window in which electrical signals are to be communicated or the points at which a measurement is to be taken.

The extended contact coil 510 may be defined by a first end 530a and a second end 530b which are separated from one another by an external angle θ. The extended contact coil 510 may extend through an internal angle (which, with reference to FIG. 5a, may be defined as 360−θ) of at least 90 degrees, or at least 180 degrees or at least 270 degrees. Other than the elongate nature of the coil, the extended contact coil 510 may be conventional in many respects and may comprise a planar winding which can be used to transmit and receive electrical signals as described herein.

The extended contact coil may be provided as the stationary transceiver 230, the transducer transceiver 232, or both.

In the case of FIG. 5a, the extended contact coil 510 is taken to be the stationary transceiver 530 with the transducer transceiver 532 being shown as a circular coil when viewed in plan, as shown. The transducer transceiver 532 is configured to move in a circular path around the rotational axis 518 as indicated by the arrow so as to pass along the arcuate length of the stationary transducer 530. Thus, the two transceivers 530, 532 as shown in FIG. 5a are fully aligned such that electrical signals may be transmitted between the two transceivers.

FIG. 5b shows a second time window in which the transducer transceiver 532 has travelled to the opposite side of the rotational axis 518 such that the transducer transceiver 532 is located between the first 530a and second 530b ends of the stationary transceiver 530 with the two transceivers being misaligned and there being no coupling between the two and no communication. As will be appreciated, as the transducer transceiver 532 rotates around the rotational axis, the transceivers will alternate between aligned and misaligned states so as to define a data transmission window during the aligned portions for each rotation.

FIGS. 6a and 6b show an alternative distributed transceiver arrangement 610 in which there is provided a plurality of discrete transceivers 630a-h distributed around the rotational axis 618 such that the opposing corresponding transceiver 632, which may be the other of the transducer transceiver 232 or stationary transceiver 230, sequentially passes each of the distributed transceivers in turn.

In FIG. 6a, there is shown a transducer transceiver 632 which is between two adjacent stationary transceivers 630a,b in a position where there is no communication, which progresses to FIG. 6b after a period of rotation so as to align the two transceivers 632, 630b.

The number and shape of the respective transceivers may be any suitable for a particular application. Hence, although FIGS. 6a and 6b show eight stationary transducers 630a-h evenly distributed around the rotational axis 618, this need not be the case and there may be a different number of transceivers ranging, for example, between two and sixteen. The number of transceivers may be 2^{N} where N is an integer. A practical maximum number of transceivers may be 128 for a large bearing.

The transceivers may be unevenly distributed about the rotational axis 618 and race 612. Either or both of the transducer transceiver 632 and the stationary transceiver 630a-h may be distributed and may comprise a plurality of discrete transceivers.

The transducer transceiver 632 is shown as having an oval footprint but, as with the other embodiments, this is an example and any suitable shape may be used and the transceivers may comprise an extended contact coil as previously described.

Returning to FIG. 2, the stationary transceiver 230 may be housed within a unit which is located adjacent to the bearing in use so as to be provided in a close enough relation to provide the wireless coupling. In order to do this, the stationary transceiver 230 may be held within a transceiver device which may be mounted or fixed to a stationary part of the bearing or a surrounding structure. The transceiver device may comprise a body in which the transceiver is mounted and an output wire or wiring which is configured to be connected to the electrical signal unit 228. As noted above, it will be appreciated that, in some embodiments, the connection between the transceiver device and electrical signal unit may comprise a wireless link.

In some examples, the transceiver device may be a handheld device comprising one or more locating features which allow the device to be located against or adjacent to a bearing in a predetermined location in order for the required data transfer to occur and the measurements taken. In other examples the transceiver device may be permanently attached to the bearing arrangement.

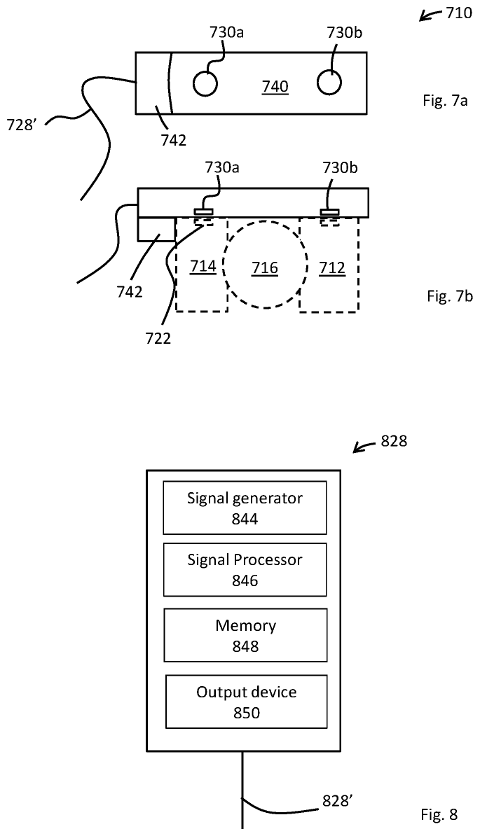

FIGS. 7a and 7b show an example of a handheld transceiver device 710 comprising a body 740, a locating feature 742, a first transceiver 730a and a second transceiver 730b and an output line 728′ for connecting to the electrical signal unit 228. Also shown is the bearing comprising rolling elements 716 and inner 712 and outer 714 races with embedded transducer/transceivers 722. The first and second transceivers 730a,730b may be coils as described above and may be circular when viewed in plan, but may take other shapes such as an elongate extended contact coils or distributed coils, as described herein. The first and second transceivers 730a,b may correspond to an inner race stationary transceiver and an outer race stationary transceiver which are positioned over the respective bearing races and transducer transceivers accordingly. It will be appreciated that, in some examples, there may only an inner race or outer race transceiver or transceivers in some embodiments and having both is optional.

The transceiver device 710 may comprise a locating feature 742 which can be used to locate the transceiver device 710 against a bearing or an associated structure. As can be seen in FIG. 7b, the locating feature 742 may be a step in the body 740 of the device 710 which provides a shoulder against which the outer race 714 of the bearing can be located, for example. However, the form of the locating feature 742 will be application specific and any locating feature may be possible. As noted above, the locating feature 742 may be used to locate the transducer device against a bearing by hand to allow a measurement to be taken whilst temporarily but accurately positioned. This allows the same transducer device 710 to be used to capture data from a plurality of bearings at different locations. Providing a hand held device can save on installation costs for example. In some examples, the transceiver device 710 may be permanently mounted at a bearing location. In yet other examples, the transceivers may be mounted directly to the bearing or a surrounding structure without the need of a separate transceiver device.

In some examples, the wireless coupling may only be used to obtain data from a rotating race, with the stationary race being hardwired in a conventional way.

An electrical signal unit which may be used as part of the invention is shown in further detail in FIG. 8. The electrical signal unit 828 may comprises a signal generator 844, a signal processor 846, a memory 848 and an output device 850.

The signal generator 844 may be any suitable signal generator known in the art for generating signals for ultrasonic transducers. The signal generator may comprise one or more of a voltage-controlled oscillator, a direct digital synthesiser, DDS, or an arbitrary waveform generator, AWG. The signal generator may comprise a field programmable gate array, microprocessor or digital signal processor. It will be appreciated that the signal may be modulated in some way to allow the wireless transmission across the wireless coupling, as well known in the art.

The signal processor 846 may be any suitable signal processor known in the art. The signal processor 849 may be configured to receive the response signal from the transducer 222 and process the signal to obtain data in relation to one or more parameters or characteristics of the bearing. The response signal may be analysed in the time domain or frequency domain using well known signal processing techniques.

The characteristic of interest in the response signal may relate to the amplitude of the signal, for example, the peak to peak voltage, or the phase of the signal which may relate to the phase difference between the incident wave and the reflected wave and be indicative of the time of flight.

The measurement techniques used within the described systems may include through-transmission and pulse-echo. The measurements techniques be time domain or frequency domain. The signals may be processed using an ultrasonic pulser receiver and/or vector network analyser which provides information on the amplitude and phase of the reflected signal.

The memory 848 may include one or more memory devices which may be configured to store code/instructions that, when read by a processor, causes performance of any of the methods described herein, and/or as illustrated in in the drawings. For example, the memory may comprise: volatile memory, for example, one or more dynamic random access (DRAM) modules and/or static random access memory (SRAM) modules; and/or non-volatile memory, for example, one or more read only memory (ROM) modules, which for example may comprise a Flash memory and/or other electrically erasable programmable read-only memory (EEPROM) device. The code may for example be software, firmware, or hardware description language (HDL) or may be any combination of these or any other form of code for one or more processing devices that is known by a person skilled in the art.

The memory 848 may be used to store the response signal or data relating to the response signal for processing at a later stage. Thus, a plurality of data may be captured and downloaded to a separate device for storing and analysing at a later date.

The memory 848 may further comprise one of more databases of known data corresponding to a bearing being measured. Thus, once a measurement has been carried out, the data can be compared to known data to determine whether the bearing is within a permitted range. The permitted range may correspond to one or more permitted operational tolerances in relation to the characteristic. Where the bearing is not in a permitted range an output may be provided to a user such that an appropriate action may be taken. The action may comprise scheduling maintenance, carrying out one or more further measurements or tests on the bearing or shutting down the machine in which the bearing is located in the event of a serious fault. Other consequential actions may be possible. The known data may be modelled data, empirically derived data or historic data for the bearing being tested, for example. Other known data may be used and other methods of determining whether a bearing is operating outside of a permitted envelope may also be employed. For example, the measured data may be inputted to a trained machine learning model or some other algorithm which allows the data to be assessed and a determination made as to whether the measured characteristics of the bearing are acceptable.

The output device 850 may be configured to generate and provide an output which is indicative of the measured data or a characteristic or condition of the bearing. The output device may be any suitable device known in the art. The output device 850 may be a display screen for example. The display screen may be the screen of an oscilloscope or a network analyser, a personal computer or some other computing device which can be utilised to convey the result of the measurement. In some examples, the display may be a simple visual indicator such as an illuminated display which may provide a colour coded output indicating that the bearing is operating correctly or incorrectly. Other output devices may include an audible output such as provided by a speaker or siren. In other examples, the output device may provide a signal for transmission to separate device or remote user.

The electrical signals may be inputted and outputted using one or more cables or wires shown generally at 828′.

Although shown as being part of a common unit, it will be appreciated that the various parts of the electrical signal unit 828 may be distributed and carried out in separate locations by different devices.

The systems described herein may be configured to measure various parameters in order to determine one or more characteristics of the bearing or machine in which the bearing is located. The system and measurements may be used as part of a health monitoring system in which faults in a machine or apparatus are detected from various parameters prior to the fault becoming problematic for the operation of the machine or apparatus.

The passing frequency of the transceivers 230, 232 may be used to determine speed of the inner or outer race and thus the speed of the rotating shaft or body which is supported by the bearing. The passing frequency may correspond to the number of times the respective transceivers pass each other per rotation. The alignment of the transceivers may be determined by a successful transmission of data or by monitoring one or more electrical parameters associated with the transceivers, such as the inductance which will change as the alignment changes.

A further characteristic or parameter which may be determined or measured is the slippage of one or more rolling elements. Rolling element slippage is a phenomenon experienced in some rolling element bearings in which the rolling elements slips or skids against the race at the contact surface, rather than rolling. Slippage may result from a defective part or an issue associated with a reduced or uneven radial loading. Slippage may be indicative of a fault in the bearing and the detection of slippage may be an important parameter or characteristic to monitor in some applications.

Slippage may be measured by comparing rolling element speed about the rotational axis with the rotational speed of the rotating race. Thus, where the passing frequency of the transceivers 230, 232 does not correspond to the passing frequency of the loaded rolling elements, the difference may be assumed to be slippage. In some examples, the speed of the rotation of the shaft may be determined using the rotating race using the rotating transducer, and the load variations created by the rolling elements in the stationary race.

Further parameters which may be measured or determined are rolling element axial loads and radial loads using time of flight measurements through the race. The axial and radial loads may be obtained using pulse signals or a phase monitoring technique for a continuous wave. Mechanical flaws such as rolling element damage or race damage may be measured by using an ultrasonic acoustic response to detect cracks or other measurable changes in the one or more rolling elements or measurements taken from different locations around the race for the same or different rolling elements. In some examples it may be useful to compare measurements from different rolling elements in corresponding locations, to measure one or more rolling elements through a predetermined arc, or to measure each of the rolling elements through the same predetermined arc. It will be appreciated that the distributed transceivers having either the elongate coils or distributed coils shown in FIGS. 5a,b and 6a,b may be well suited to these types of measurements.

Yet further parameters or characteristics which may be determined or measured using one or more of the systems described herein are lubricant film thickness, lubricant contamination, lubricant quality or other lubricant properties such as viscosity. These quantities may be measured using an ultrasonic interrogation due to the effect the lubricant film has on the amount of energy transferred into the lubricant film owing to changes in the interfacial stiffness. By taking measurements and comparing them to historic measurements or known measurements, it may be possible to determine what the properties of the lubricant are and when the lubricant may be insufficient or require changing.

Yet further parameters which may be measured or determined include vibration and acoustic emission shockwaves which occur due to a bearing being damaged in some way. Such parameters may be detected using passive ultrasonics to listen to noise in the system.

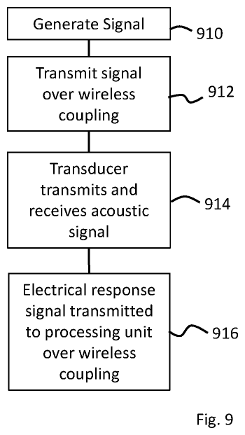

With reference to FIGS. 2, 8 and 9, in use, the signal generator generates at step 910, a suitable signal, e.g. a pulse signal, for exciting the ultrasonic transducer. The signal is transmitted to the transducer transceiver over the wireless coupling for delivery to the transducer at step 912. The transducer receives the pulse signal and is excited to generate an acoustic wave at step 914. An acoustic response, e.g. a reflected portion of the acoustic wave, is subsequently received by the transducer which generates a corresponding electrical response signal for transmitting back to the electrical signal unit via the wireless coupling at step 916. The electrical signal unit receives and stores and/or processes the received electrical signal.

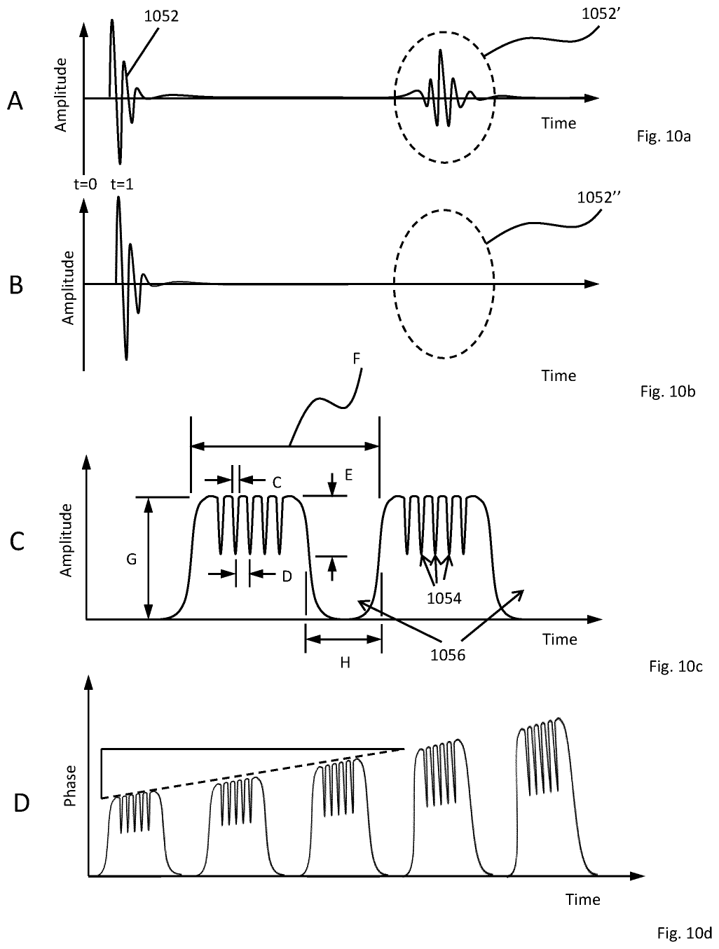

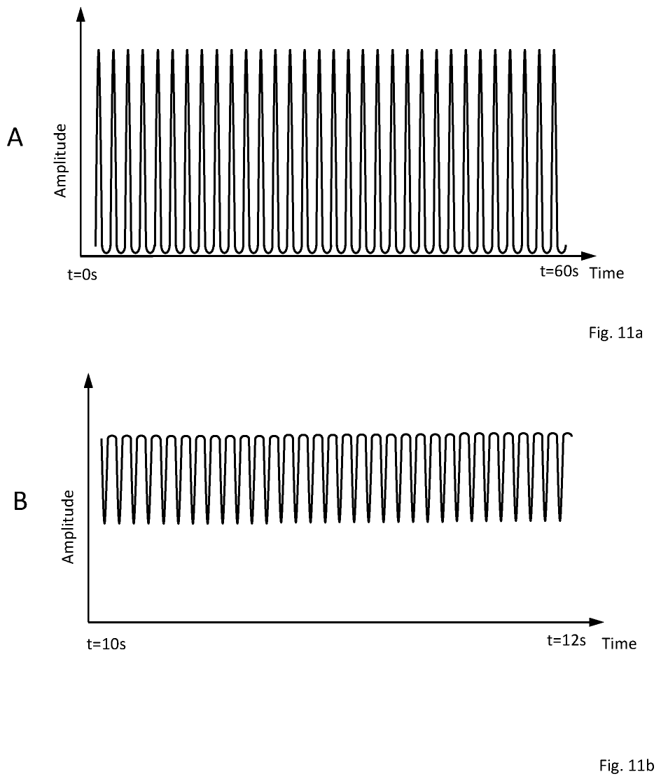

FIGS. 10a-10d show various electrical signals generated by the system which are described in connection with FIGS. 2, 3 and 4 which may provide the apparatus for generating the signals.

FIG. 10a shows an input pulse signal 1052 which is transmitted to the transducer 222 via the wireless coupling 226 at a first time, t=0. The pulse signal 1052 is generated by the signal generator 844 and transmitted to the stationary transceiver 230. The pulse 1052 has an amplitude as indicated by the y-axis and is shown in the time domain as indicated by the x-axis. The pulse 1052 can be of any suitable form required for generating the required acoustic signal.

The transducer 222 is excited and an associated acoustic pulse is transmitted along the wave transmission path with the reflected wave 1052′ being subsequently received by the transducer 222 and transmitted across the wireless coupling 226 to the electrical signal unit 228 at time t=1. The received reflected signal is then processed to derive one or more characteristics of the reflected signal using known techniques. The characteristics of the signal may include the amplitude and phase of the received signal or may include any other characteristic known in the art. Exemplary characteristics may include frequency content, amplitude, phase, time-frequency.

The difference between t=0 and t=1 is typically may be in the order of 10 microseconds which corresponds an upper limit of approximately 100 kHz pulsing speed to 10 ms which corresponds to a lower limit of approximately 1 kHz pulsing speed (for large bearings). Typically, the pulsing speed will be approximately 20 kHz in many applications.

FIG. 10b shows a similar plot, however, in this case the transceivers 230, 232 of the wireless coupling 226 are not aligned and so there is no transmission of the pulse signal provided by the signal generator 844 and so reflected pulse. Hence, at time t=1, no reflected pulse is received at the electronic signal unit 228 as indicated by the dashed line at 1052″.

It will be appreciated that, although FIGS. 10a and 10b show binary states between aligned and misaligned transceivers, in reality there will be partial coupling as the transceivers 230, 232 come into alignment and move out of alignment. The wireless coupling will also be affected by the separating gap and the size of the coils, for example, as is known in the art.

FIGS. 10c and 10d show the amplitude and phase of received electrical signals transmitted over the wireless coupling 226 over an extended period of time between t=0 to t=n, wherein n is an arbitrary number of seconds extending over a number of revolutions of the rotating body and one of the races. The plots shown in FIGS. 10c and 10d consist of data taken from pulsed signals provided at a predetermined sampling rate. The sampling rate may be in the order of kHz. For example, the sampling rate may be between 10 kHz and 25 kHz The sampling frequency may be determined by the frequency content of the pulse which may typically be in the 1-10 MHz range. The sampling frequency may be 10 times higher than the frequency content so 10-100 MHz. It will be appreciated that the signal may not be sampled when the processing uses analogue circuit.

Looking first at FIG. 10c, there is shown the amplitude G of the reflected pulse received by the transducer 222, e.g. the peak to peak amplitude. The waveform comprises a series of minor troughs 1054 which are interspersed with major troughs 1056. The major troughs represent portions of misalignment where the reflected signal is reduced or no reflected signal is received (or generated signal transmitted) due to the transceivers 230, 232 being misaligned and corresponds to the situation provided in FIG. 10b. Thus, the wireless coupling and data transmission has a periodicity F defined by the separation of the major troughs which represents a speed of rotation of the rotating body, assuming the wireless coupling drops out of alignment once per revolution. The term trough is used nominally and may refer to any reduction in the response signal as a loss or drop off in the wireless coupling.

Between the major troughs, the transceivers 230, 232 are in alignment and the amplitude G of the received signal is shown. The received signal comprises a series of minor troughs 1054, each of which correspond to a rolling element passing the transducer 222 which creates local loading of the race and/or affects the interfacial stiffness of the lubricating film. Hence, where the rolling elements pass, there is a reduction in the peak-to-peak amplitude of the received reflected signal.

Each minor trough will have an amplitude E, a duration C and a separation from an adjacent minor trough, or period, D. These characteristics, or more generally, the shape and size of the minor troughs, can be used to determine various characteristics associated with the rolling elements. For example, the duration C of the minor trough may be used to determine the contact time of the rolling element as it passes the sensor. The separation of the contact regions D can be used to determine the speed of the rolling elements which may be used in conjunction with the rotational speed to determine whether there is any slippage in one or more of the rolling elements. The magnitude E of the minor troughs can be used to determine the magnitude of the load being experienced by each rolling element or properties of the lubricating film.

FIG. 10d shows the phase of the received signal which corresponds to the time of flight for the acoustic signal. That is, the condition and loading of the race and/or lubricating film alters the speed of the acoustic signal which manifests itself in a change in phase. As can be seen, the phase plot shows many of the same features as the amplitude plot and includes the alignment characteristics (major troughs) and the load characteristic (minor troughs) for the rolling elements which occur due to the change in time of flight as a result of the local loading of the race.

In addition to the above, the phase can be used to determine a change in temperature. Thus, tracking the gradient of the phase can give an indication of temperature and, more specifically, a change in the temperature.

More specifically, the change in the time of flight and/or the gradient may be indicative of the temperature of the bearing. The change in time of flight and/or gradient may be compared with previously obtained or predetermined data to provide a temperature measurement. Alternatively or additionally, the change in time of flight or gradient may be used to determine a change in temperature.

It will be appreciated that the data used to produce the waveforms in FIGS. 10c and 10d may be acquired using any of the transceiver arrangements described above, such as the extended contact transceivers 530 described above in connection with FIGS. 5a and 5b which provide an extended data capture window from around the rotational axis of the bearing. Using the extended contact coils 530 allows the data to be captured for the majority of a revolution whilst providing a short misalignment trough for monitoring the rotational speed.

The data shown in FIGS. 10c and 10d may be captured using both the inner and outer race of a bearing. For example, in a bearing with a stationary outer race and a rotating inner race, the inner race may be used to determine the speed of rotation by analysing the alignment and misalignment timings of the transceivers. The stationary outer race may be used to acquire data relating to the loading of the rolling elements. In such a scenario, the stationary 230 and transducer 232 transceivers for both the inner and outer races may be short coils which only transmit data for a small fraction of a rotation rather than the extended contact coils 530 or the distributed coils 630a-h of FIGS. 5a,b and 6a,b.

FIGS. 11a and 11b show plots for a rotating inner race and a stationary outer race. More specifically, FIG. 11a shows a plurality of test pulses being transmitted to and reflected back from the inner race transducer 222 during aligned and unaligned periods. FIG. 11b shows the data acquired from the stationary outer race which show the load profile of the race changing as the rolling elements pass the transducer. The data acquired from the inner and outer races may be used to provide a composite plot as shown in FIGS. 10c and 10d.

The use of a wireless coupling 226 allows for relative rotation between a bearing component and a transceiver. The passing frequency of transceivers used in the wireless coupling may be used to provide information about the rotational speed of the race and/or rotating component in addition to data which can be conventionally extracted using ultrasonics. Further, monitoring the passing frequency of the rolling elements and the rotational speed of the race allows additional characteristics such as rolling element slip to be detected. Additionally or alternatively, using distributed transceivers or extended contact transceivers which cover an extended arcuate length of a race allow a greater amount of data to be gathered. Placing transceivers on the inner and outer race allows different characteristics to be monitored and a composite waveform to be produced thereby providing improved information for a user of the system.

Although the above described embodiments are specific to bearings, and more so to rolling element bearings, it will be appreciated that the rotating system may not be a bearing and the invention may be applied to other components which move relative to one another. The relative movement may be rotational or linear or reciprocating. Thus, there may be provided a wireless ultrasonic transducer arrangement for determining a parameter of two components which are configured to move relative to each other, wherein the two components comprise an inner component and an outer component having relative movement therebetween; an ultrasonic transducer mounted to either the inner component or the outer component and a transducer transceiver electrically connected to the transducer and configured to wirelessly transmit electrical signals for the transducer. The arrangement may comprise a wireless coupling comprising: the transducer transceiver electrically connected to the transducer and a stationary transceiver electrically connectable to an electrical signal unit, wherein the transducer transceiver and the stationary transceiver are arranged in a spaced relation and configured to transmit electrical signals between the transducer and an electrical signal unit. Other features as described herein may be applicable to this general arrangement.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1-10. (canceled)

11. A wireless ultrasonic transducer arrangement for a rolling element bearing comprising:
a bearing comprising an inner race and an outer race having a plurality of rolling elements therebetween, and defining an axis of rotation about which the inner and outer race rotate relative to one another;
an ultrasonic transducer mounted to either the inner race or the outer race;
a transducer transceiver electrically connected to the ultrasonic transducer;
an electrical signal unit; and
a stationary transceiver wirelessly coupled to the transducer transceiver and electrically connected to the electrical signal unit,
wherein the transducer transceiver and the stationary transceiver are configured to rotate relative to one another, and further configured to wirelessly transmit electrical signals between the ultrasonic transducer and the electrical signal unit, and
wherein the electrical signal unit is configured to determine a characteristic of the bearing based on a passing frequency of the transducer transceiver relative to the stationary transceiver.

12. The wireless ultrasonic transducer arrangement of claim 11, further comprising a plurality of transducer transceivers and/or a plurality of stationary transceivers.

13. The wireless ultrasonic transducer arrangement of claim 11, wherein the transducer transceiver and/or the stationary transceiver is configured to transmit the electrical signals around an arc of at least 90 degrees of the axis of rotation.

14. The wireless ultrasonic transducer arrangement of claim 11, wherein the stationary transceiver comprises at least one electrical coil.

15. The wireless ultrasonic transducer arrangement of claim 11, comprising a plurality of stationary transceivers distributed around the axis of rotation.

16. The wireless ultrasonic transducer arrangement of claim 15, wherein the plurality of stationary transceivers include an inner race stationary transceiver and an outer race stationary transceiver.

17. The wireless ultrasonic transducer arrangement of claim 11, further comprising a transceiver device comprising the stationary transceiver, wherein the transceiver device is arranged in a fixed relation to the axis of rotation.

18. The wireless ultrasonic transducer arrangement of claim 17, wherein the transceiver device comprises one or more locating features for locating the transceiver device adjacent to the transducer transceiver on either or both of the inner or outer race in a predetermined position.

19. (canceled)

20. The wireless ultrasonic transducer arrangement of claim 11, wherein the characteristic of the bearing includes any one or more of the group consisting of: a rotational speed of the inner or outer race; a bearing slip; a raceway temperature; a mechanical flaw in the bearing; one or more characteristics of a lubricant located between the inner or outer race; and vibration.

21. The wireless ultrasonic transducer arrangement of claim 11, wherein the electrical signal unit comprises an output device configured to output the characteristic of the bearing to a user.

22. A method of determining one or more characteristics of a rolling element bearing using a wireless ultrasonic transducer arrangement comprising:
a bearing comprising an inner race and an outer race having a plurality of rolling elements therebetween, and defining an axis of rotation about which the inner and outer race rotate relative to one another;
an ultrasonic transducer mounted to either the inner race or the outer race;
a transducer transceiver electrically connected to the ultrasonic transducer;
an electrical signal unit; and
a stationary transceiver wirelessly coupled to the transducer transceiver and electrically connected to the electrical signal unit,
the method comprising:
transmitting an excitation electrical signal over a wireless coupling between the stationary transceiver and the transducer transceiver;
receiving the excitation electrical signal by the ultrasonic transducer from the transducer transceiver;
generating, by the ultrasonic transducer, an acoustic wave in response to the excitation electrical signal;
receiving a response acoustic wave at the ultrasonic transducer;
generating, by the ultrasonic transducer, a response electrical signal corresponding to the response acoustic wave;
transmitting the response electrical signal over the wireless coupling to the electrical signal unit.

23-27. (canceled)

28. The wireless ultrasonic transducer arrangement of claim 14, wherein the at least one electrical coil extends around an arc of at least 90 degrees with respect to the axis of rotation.

29. The wireless ultrasonic transducer arrangement of claim 11, wherein the transducer transceiver comprises a plurality of discrete sub-transceivers distributed around the axis of rotation.

30. The wireless ultrasonic transducer arrangement of claim 11, wherein the transducer transceiver comprises an electrical coil.

31. The wireless ultrasonic transducer arrangement of claim 30, wherein the electrical coil is elongate and extends around the axis of rotation.

32. The wireless ultrasonic transducer arrangement of claim 31, wherein the electrical coil extends around at least 90 degrees.

33. The wireless ultrasonic transducer arrangement of claim 11, wherein the ultrasonic transducer is an inner race transducer and the wireless ultrasonic transducer arrangement further comprises an outer race transducer.

34. The wireless ultrasonic transducer arrangement of claim 11, wherein the ultrasonic transducer is embedded within the inner race or outer race.

35. The wireless ultrasonic transducer arrangement of claim 34, wherein the ultrasonic transducer is embedded within an axial face of the inner race or outer race.

36. The wireless ultrasonic transducer arrangement of claim 11, wherein the ultrasonic transducer transceiver is directly mounted on the inner race or outer race.
